(19) United States
(12) Patent Application Publication
(10) Pub. No.: US 2014/0224360 A1
(43) Pub. Date: Aug. 14, 2014

(54) SUBMERSIBLE SUCTION BOX

(71) Applicant: Air and Liquid Systems, Inc., Rochester Hills, MI (US)

(72) Inventors: James E. Miller, Troy, MI (US); Gordon T. Urquhart, Birmingham, MI (US)

(73) Assignees: Gordon T. Urquhart, Birmingham, MI (US); James E. Miller, Troy, MI (US)

(21) Appl. No.: 14/178,402

(22) Filed: Feb. 12, 2014

Related U.S. Application Data
(60) Provisional application No. 61/764,239, filed on Feb. 13, 2013.

(51) Int. Cl. B01D 21/24

(52) U.S. Cl. CPC B01D 21/245
USPC 137/565.23

(57) ABSTRACT

A submersible suction arrangement for providing paint sludge removal from one or more contaminant tanks in an automotive paint line systems. The contaminant tank is filled with a liquid mixture and includes a horizontal plane defined by the walls of the contaminant tank. The contaminant tank also has a total vertical depth between the top opening and the bottom surface of the contaminant tank. At the bottom of the contaminant tank is a paint sludge layer formed on at least a portion of the bottom surface of the contaminant tank. The submersible suction arrangement includes a submersible suction unit that removes the paint sludge layer at a location beneath the surface of the liquid mixture.

### CROSS-REFERENCE TO RELATED APPLICATIONS

This application claims the benefit of U.S. Provisional Application No. 61/764,239, filed Feb. 13, 2013.

### FIELD OF THE INVENTION

The present invention relates to devices and systems for filtering contaminants such as paint, sludge and oil from a solution.

### BACKGROUND OF THE INVENTION

During the manufacture of painted parts, such as automotive body parts industrial wastes are produced. By-products such as paint sludge particles and oils are produced and require proper disposal. Systems for concentrating, filtering and removing paint sludge particles and oils from mixtures derived from industrial solutions are necessary to meet environmental standards.

A common technique for capturing paint overspray/airborne paint particulate produced when operating a paint spray booth is to capture the particulate in a waterfall backdrop within the spray booth. The resulting water-and-particulate fluid mixture is then channeled into a suitable system in which the paint particulate is substantially removed from the water. The filtered water is thereafter advantageously recirculated back to the spray booth's waterfall backdrop to capture more airborne paint particulate.

It is desirable to develop improved systems that separate paint sludge more effectively. Thus, it is desirable to develop systems that can adapt and account for varying conditions such as the coagulation of paint sludge at the surface of a waste contamination tank as well as removal of the coagulated paint sludge that can collect at the bottom of a fluid tank.

### SUMMARY OF THE INVENTION

The present invention is directed to a submersible suction arrangement for providing paint sludge removal from one or more contaminant tanks. The contaminant tank has a top opening bordered by walls and a bottom surface. The contaminant tank is filled with a liquid mixture and includes a horizontal plane defined by the walls of the contaminant tank. The contaminant tank also has a vertical depth between the top opening and the bottom surface of the contaminant tank and a total vertical depth between the surface of the liquid mixture and the bottom surface of the contaminant tank. At the bottom of the liquid mixture is a paint sludge layer formed on at least a portion of the bottom surface of the contaminant tank. The submersible suction arrangement includes a submersible suction unit that removes the paint sludge layer at a location beneath the surface of the liquid mixture. The submersible suction unit is movable to one or more locations or points within the horizontal plane of the contaminant tank and the submersible suction unit is movable to one or more vertical depths beneath the surface of the liquid mixture. The submersible suction arrangement also has a suspension frame connected to the submersible suction unit for moving the submersible suction unit to one or more locations within the horizontal plane or the one or more vertical depths.

The submersible suction unit also includes a housing that has a buoyancy chamber contained within the housing. The buoyancy chamber is connected to an air inlet for supplying compressed air to the buoyancy chamber. When compressed air is supplied to the buoyancy chamber, the housing becomes more buoyant and the submersible suction unit can rise from the bottom surface of the contaminant tank to a select vertical depth. The submersible suction unit housing also has a suction passage extending through the housing between a paint sludge suction inlet and a sludge outlet formed in the housing. When a portion of the paint sludge layer is removed by the submersible suction unit through the suction inlet of the housing, the paint sludge flows through the suction passage and exit the submersible suction unit through the sludge outlet where the paint sludge travels to the suction pipe. Also attached to the housing of the submersible suction unit is a set of feet that are adjacent the paint sludge suction inlet for allowing the housing to stand on the bottom surface of the contaminant tank, while keeping the paint sludge suction inlet off of the bottom surface of the contaminant tank so it does not become blocked or clogged.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a cross-sectional side plan view of a submersible suction arrangement in accordance with a first embodiment of the present invention;

FIG. 2 is an overhead plan view of the submersible suction arrangement in accordance with a first embodiment of the present invention;

FIG. 3A is a side view of the submersible suction arrangement schematically connected to a suspension frame in accordance with the present invention;

FIG. 3B is an exploded perspective schematic view of the toggle valve in accordance with one aspect of the present invention;

FIG. 4A is a schematic side view of the submersible suction arrangement in accordance with a second embodiment of the invention;

FIG. 4B an overhead plan view of the submersible suction arrangement in accordance with the second embodiment of the present invention.

### DETAILED DESCRIPTION OF THE PREFERRED EMBODIMENTS

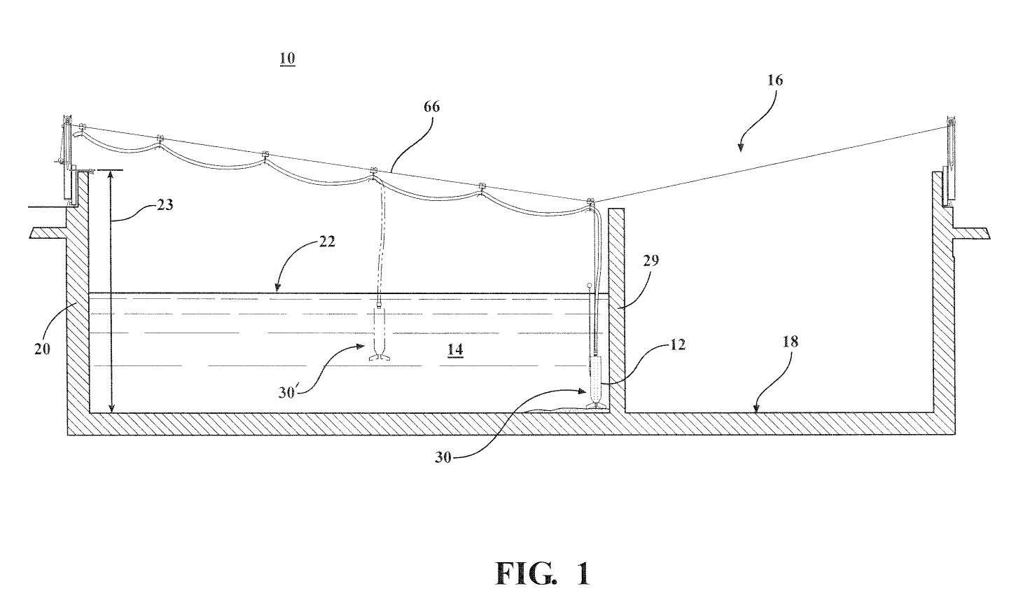

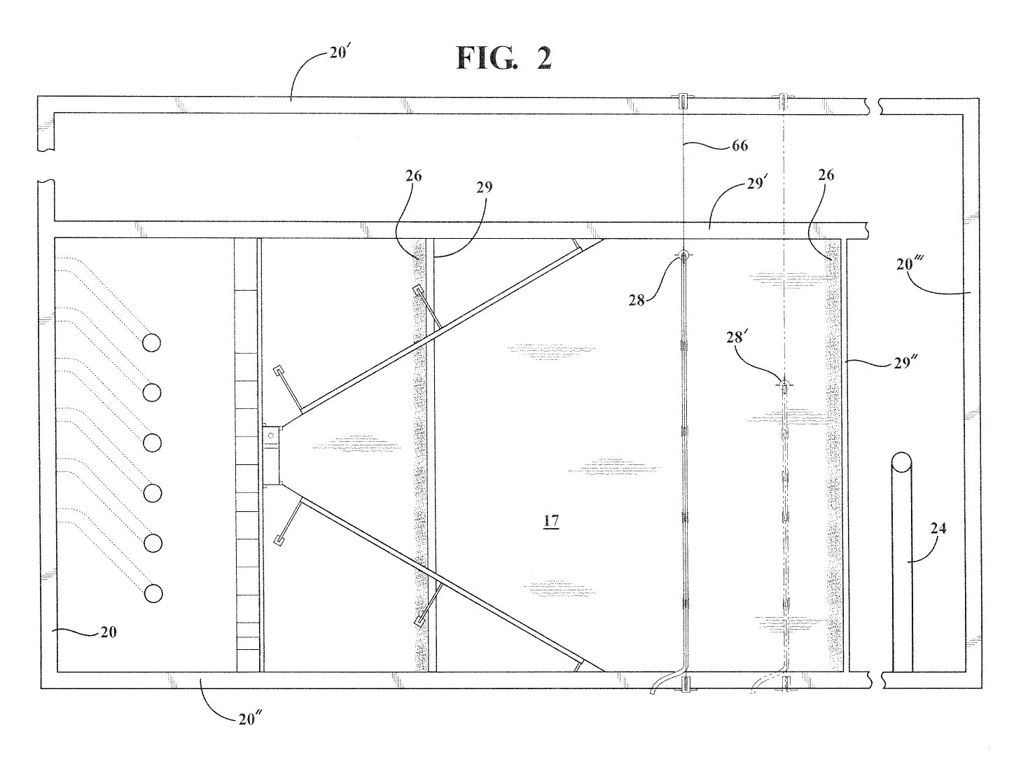

Referring now to all of the Figures, with particular reference to FIGS. 1 and 2, a submersible suction arrangement 10 is shown. The submersible suction arrangement 10 includes a submersible suction unit 12 used in connection with a contaminant tank 14. The contaminant tank 14 has a top opening 16, bottom surface 18 and side walls 20, 20′, 20″, 20′″. The contaminant tank 14 is configured to receive and hold a liquid mixture, which can be water or other suitable solutions used in connection with the painting of automotive bodies and parts. Within the liquid mixture are particles of paint which have been captured during the process of painting the parts. The contaminant tank 14 can have many different shapes and structures. For example, the contaminant tank 14 can include pump screens and be subdivided into separate tanks where paint sludge is removed from a main tank and moved to a consolidation tank where the paint sludge is more concentrated and can be removed using stationary weirs or floating weirs in accordance with other techniques for removing paint sludge. Different variations of the contaminant tank 14 and other arrangements which can be used in connection the submersible suction arrangement 10 in accordance with the present invention, are described in U.S. Pat. No. 8,277,652 issued to Urquhart et al. (hereafter referred to as Urquhart), the entire disclosure of which is hereby expressly incorporated by reference. The submersible suction arrangement 10 of the present invention may be used with other paint sludge removal inventions and other types of tanks such as those described in Urquhart.

The contaminant tank 14 receives the liquid mixture 22 from a paint spray line. The liquid mixture 22 is pumped into the contaminant tank 14 through a liquid mixture inlet such that the liquid mixture 22 flows in a direction (shown by the arrows in FIG. 2) from the liquid mixture inlet across the contaminant tank 14. As a result of the flowing liquid mixture 22, a paint sludge layer 26 may form at one or more locations along the bottom surface 18 of the contaminant tank 14, which is a result of the liquid mixture being more stagnant in certain locations of the contaminant tank 14. For example, in the embodiment shown in FIG. 2, the contaminant tank 14 includes several divider walls 29, 29′, 29″ where several paint sludge layers 26 collect on the bottom surface on the downstream side of the individual divider walls 28 in the contamination tank 14. Over time, the paint sludge layer 26 can become several feet thick and must be removed from the contaminant tank 14. One traditional way of removing the paint sludge layer 26 is to drain the liquid mixture 22 from the contaminant tank 14 and then manually remove the paint sludge layer 26. This presents a problem because the entire paint line must be shut down during this costly and time consuming process. In order to prevent having to shut down the paint line and drain the contaminant tank 14, the submersible suction arrangement 10 in the present invention seeks to clean or remove the paint sludge layer 26 without having to drain the contaminant tank and shut down the paint line. This is accomplished using a submersible suction unit 12 in accordance with the embodiments of the present invention.

With regard to the contaminant tank 14 in accordance with the present invention, the side walls 20 of the contaminant tank 14 define a horizontal plane 17 within the contaminant tank 14. The liquid mixture 22 defines a total vertical depth 23 which is defined as being the distance between the top surface of the liquid mixture 22 and the bottom surface 18 of the contaminant tank 14. The horizontal plane 17 and total vertical depth 23 are important because the submersible suction arrangement 10 is capable of operating at one or more horizontal positions 28, 28′ and a select vertical depth 30, 30′ which is less than the total vertical depth 23.

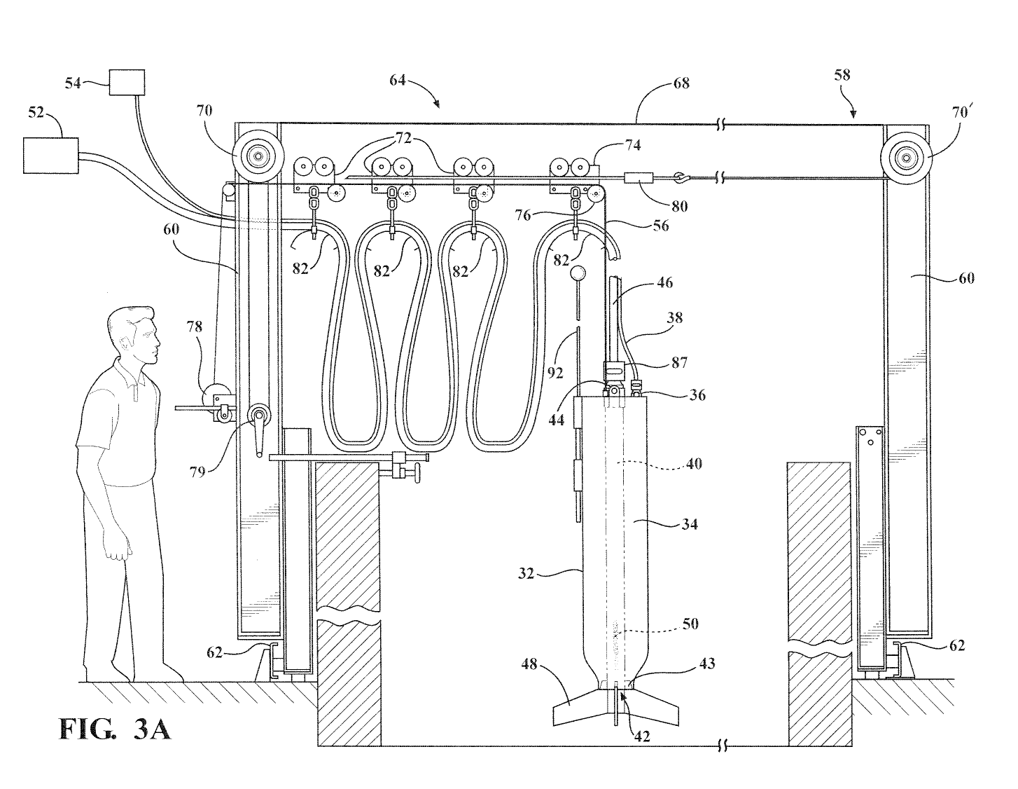

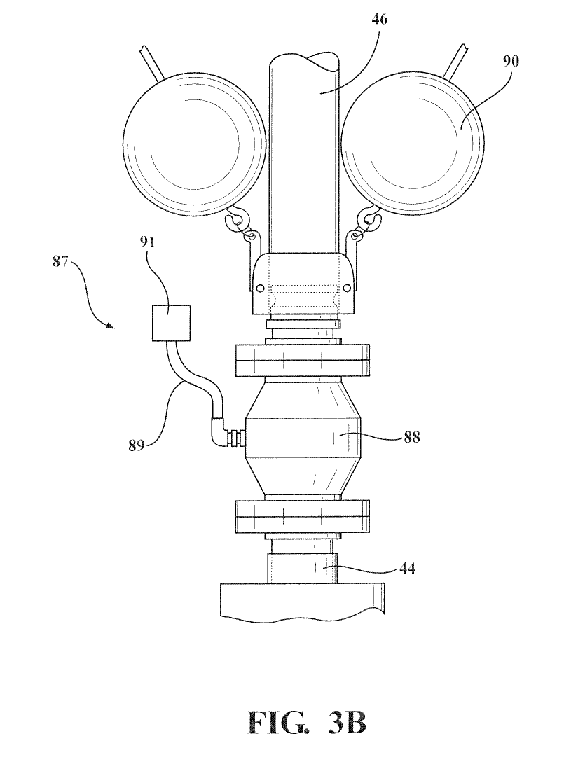

The submersible suction unit 12 includes a housing 32 that has a buoyancy chamber 34. A single buoyancy chamber 34 is shown in FIG. 3A; however, it is possible for the housing to have multiple buoyancy chambers depending on the needs of a particular application. The buoyancy chamber 34 is connected to an air inlet 36 disposed through the housing 32. An air line 38 connects to the air inlet 36 and selectively feeds and removes compressed air in the buoyancy chamber 34 using the air inlet 36. When the buoyancy chamber 34 is filled with a greater amount of compressed air, the submersible suction unit will change its buoyancy and move to the select vertical depth 30 Liquid mixture enters the buoyancy chamber though a chamber inlet 43 located at the bottom of the submersible suction unit 12. As air is removed from the buoyancy chamber 34 liquid mixture will enter the buoyancy chamber 34 thought the chamber inlet 43 and change the buoyancy of the submersible suction unit 12.

The submersible suction unit 12 also has a suction passage 40 that extends through the housing 32 between a suction inlet 42 and sludge outlet 44. The suction inlet 42 extends through the housing 32 and is connected to a suction pipe 46. The submersible suction unit 12 also includes feet 48 connected to the housing 32 adjacent the suction inlet 42. The feet 48 allow for the submersible suction unit 12 to stand on the bottom surface 18 of the contaminant tank 14 and prevent the suction inlet 42 from touching the bottom surface 18 of the contaminant tank 14, becoming blocked or clogged by the paint sludge layer 26 or the bottom surface 18.

During operation, a portion of the paint sludge layer 50 is removed from the paint sludge layer 26 through the suction inlet 42. The removal of the portion of the paint sludge layer 50 is caused by a vacuum provided by the suction pipe 46 connected the sludge outlet 44 of the submersible suction unit 12. During operation, the portion of the paint sludge layer 50 removed from the paint sludge layer 26 through the suction inlet 42 passes through the suction passage 40 to the sludge outlet 44 where the portion of the paint sludge layer 50 is removed through the suction pipe 46 and transferred to another location such as a holding or treatment tank. The vacuum provided to the suction pipe 46 is achieved by a vacuum pump 52 located externally from the submersible suction unit 12.

The compressed air provided by the air line 38 is provided by a compressed air pump 54 located externally from the submersible suction unit 12. However, it is within the scope of this invention for the vacuum pump 52 to be located on the housing 32 of the submersible suction unit. Such a pump could be an impeller style pump connected between the sludge outlet 44 and the suction pipe 46.

During operation, the submersible suction unit 12 moves within the contaminant tank 14 to various select horizontal positions 28 within the horizontal plane 17 as well as a desired select vertical depth 30 within the total vertical depth 23 of the liquid mixture 22. It is within the scope of this invention for there to be multiple select vertical depths since the paint sludge layer 26 may be thicker in certain areas of the contaminant tank than in other areas. The movement of the submersible suction unit 12 to a select vertical depth 30 is accomplished using the buoyancy chamber 34. However, it is also possible to move the submersible suction unit 12 to different vertical depths using a sling line 56 connected between the housing 32 and a suspension frame 58. The sling line 56 in one embodiment of the invention is used for completely removing the submersible suction unit 12 from the liquid mixture 22. However, the sling line 56 may also aid or completely move the submersible suction unit 12 to a select vertical depth 30 without the use of the buoyancy chamber 34 and compressed air from the air line 38. Thus, it within the scope of this invention for there to be other submersible suction units that do not have a buoyancy chamber, but rather have weighted housings that create negatively buoyant submersible suction unit(s), which will always sink in a liquid mixture and a sling line is used to control the movement of the submersible suction unit to a select vertical depth in a contamination tank.

In one embodiment of the invention shown in FIGS. 1,2 and 3A, the suspension frame 58 includes two towers 60 extending upward from the side walls 20 of the contaminant tank. Each of the two towers 60 are connected to a track 62 that extends along the length of two of the side walls 20. Connected between the two towers is a rail 64, which in the present embodiment of the invention is a cable 66 formed as a loop 68 that wraps around a wheel 70 on each one of the two towers 60. Connected to a portion of the cable are one or more support trolleys 72 that are movable along the cable 66 between the two towers 60. A lead trolley 74 is slidable along the cable 66 and has a guide 76 that the sling line 56 is connected to. During operation, the lead trolley 74 is generally located above the submersible suction unit 12 and controls the movement of the submersible suction unit 12 within the horizontal plane 17 of the contaminant tank 14. The sling line 56 in one embodiment may slide through the guide 76 to a winch 78 that may wind and unwind to cause the submersible suction unit 12 to move vertically to a desired select vertical depth 30 or to move completely out of the liquid mixture 22.

During operation, the winch 78 may become completely wound to pull the sling line upward and remove the submersible suction unit 12 from the liquid mixture so that the submersible suction unit 12 is suspended vertically above the contaminant tank 14. The submersible suction unit 12 may then be removed from the contaminant tank in the horizontal direction by pulling the cable 66 in a direction so that the loop 68 moves in a circular manner between each wheel 70. When the loop 68 moves, trolley stops 80 connected to the loop 68 and locked on either side of the lead trolley 74, will contact the lead trolley 74 and cause it to move and abut against the one or more support trolleys 72. As this occurs, the one or more support trolleys 72, lead trolley 74 and submersible suction unit 12 will begin moving toward one of the two towers 60 in order to horizontally move the submersible suction unit 12 from the contaminant tank 14, where the submersible suction unit 12 can be accessed by person(s) outside of the contaminant tank 14.

The one or more support trolley 72 and the lead trolley 74 also each include a support arm 82 that extends downward from the cable 66 and provides a rest for the suction pipe 46 and air line 38. The support arm 82 on each of the one or more support trolleys 72 and lead trolley 74 allow the suction pipe 46 and air line 38 to be suspended above the liquid mixture. This provides an advantage so that the suction pipe 46 and air line 38 are not floating on the surface of the liquid mixture 22. As described above, the liquid mixture 22 is flowing into the contaminant tank 14 through a liquid mixture inlet 24 causing a current within the contaminant tank 14. If the suction pipe 46 and air line 38 were floating on the surface of the liquid mixture 22, it could interfere with current flow of the liquid mixture 22 through the contaminant tank 14. The support arm 82 provided on the one or more support trolleys 72 and lead trolley 74 resolve this problem by suspending the suction pipe 46 and air line 38 above the liquid mixture 22.

The trolleys 72 and lead trolley 74 are connected to the cable 66, which in one embodiment of the invention shown in FIG. 3A is a circular loop 68. The loop 68 is positioned between the wheel 70 connected to each of the two towers 60. The wheel 70 on each tower 60 allows the loop 68 to be rotated when a loop winch 79 is turned. As the loop 68 rotates the trolley stop 80 contacts the lead trolley 74 and begins to move it in the direction of one of the towers 60. The lead trolley 74 will contact and push the other trolleys 72 in the same direction during rotation.

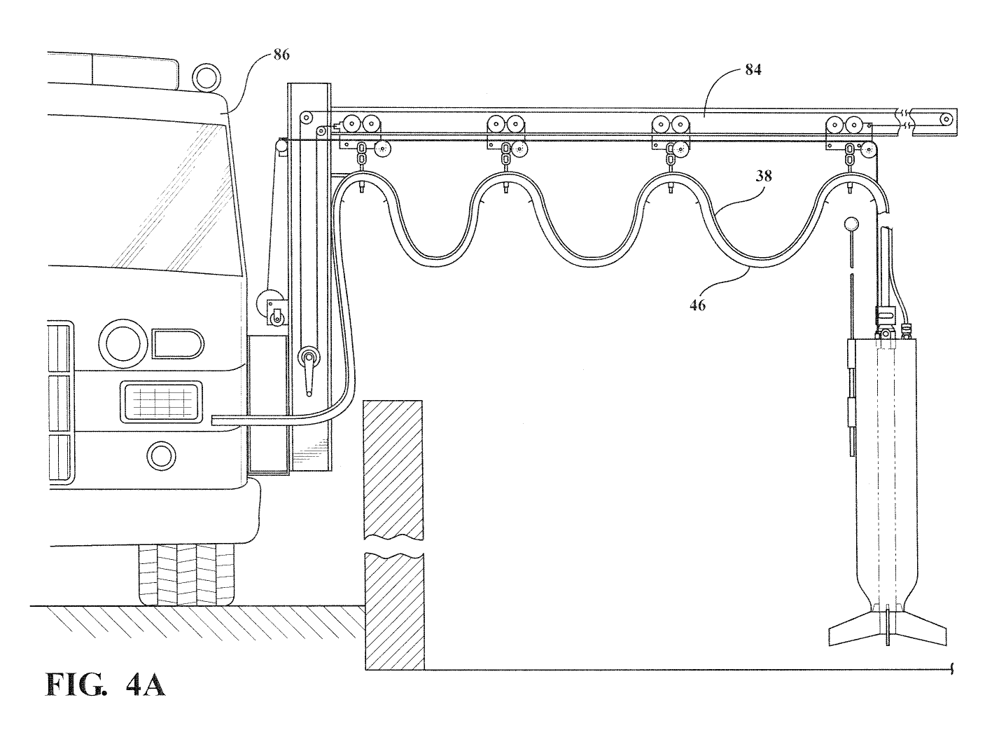

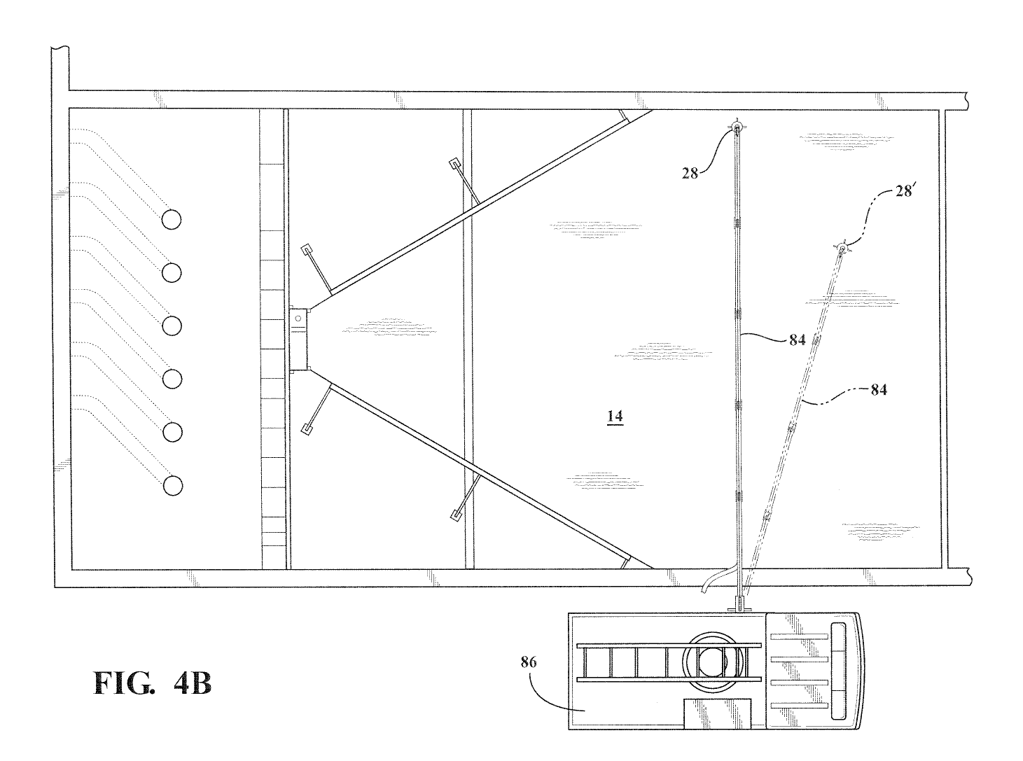

Referring now to FIGS. 4A and 4B, a second embodiment of the invention is described. In this alternate embodiment of the invention, the suspension frame 58′ is a beam 84 extending from a vehicle 86. The beam 84 is configured to swivel and move above the liquid mixture 22 of the contaminant tank and controls the deployment and movement of the submersible suction unit 12 within the liquid mixture. The vehicle 86 contains pumps and, in some cases, storage tanks for collecting the portion of the paint sludge 50 removed by the submersible suction unit 12. This particular embodiment provides the advantage of having a submersible suction arrangement 10′ that can be transported between different contaminant tanks and eliminates the need for the installment of towers and tracks as described in the first embodiment of the invention.

Referring now to FIG. 3B, an exploded view of a toggle valve used in connection with all embodiments of the invention is shown. The toggle valve 86 connects between the sludge outlet 44 and suction pipe 46. The toggle valve 86 has a diaphragm 88 that assists in priming the submersible suction unit 12 before being deployed under the surface of the liquid mixture 22. In order to provide an adequate vacuum through the suction pipe 46, the submersible suction unit 12 must be primed and the toggle valve 86 in connection with the diaphragm 88 allows for a suction to be started within the suction passage 40 of the housing 32. During the priming process, a primer line 89 is connected to the diaphragm 88. The primer line 89 is connected to a primer vacuum which applies a vacuum to the diaphragm 88 to keep the diaphragm open at the start of the flow of liquid mixture and paint sludge through the suction passage 40. Additionally, the toggle valve 86 also includes floats 90 that are connected to the valve and help to provide buoyancy compensation for the added weight when the toggle valve 86 is used.

Referring now to FIG. 3A, another aspect of the invention is shown where a flag 92 is connected to the housing 32 and extends vertically upward above the surface of the liquid mixture 22. This allows for the operator of the submersible suction arrangement 10 to provide a visual marker where the submersible suction unit 12 is located within the horizontal plane 17 of the contaminant tank 14.

1. A submersible suction arrangement comprising:
a contaminant tank having a top opening a bottom surface and side walls bordering said top opening, said contaminant tank is filled with a liquid mixture, wherein said contaminant tank has a horizontal plane defined by the side walls of the contaminant tank and a total vertical depth between a surface of the liquid mixture and the bottom surface of the contaminant tank;
a paint sludge layer formed on at least a portion of the bottom surface of the contaminant tank;
a submersible suction unit for removing said paint sludge layer beneath the top surface of the liquid mixture, wherein said submersible suction unit is movable within the horizontal plane to a horizontal position in the contaminant tank and to a select vertical depth within the total vertical depth beneath the horizontal plane of the contaminant tank; and
a suspension frame connected to said submersible suction unit for controlling the movement of the submersible suction unit.

2. The submersible suction arrangement of claim 1 wherein said suspension frame is capable of completely removing the submersible suction unit from the liquid mixture.

3. The submersible suction unit of claim 1, wherein said submersible suction unit includes:
a housing containing a buoyancy chamber connected to an air inlet;
a suction passage extending through the housing between a paint sludge suction inlet and a sludge outlet formed in the housing, wherein a portion of said paint sludge layer from said bottom surface of said contaminant tank is removed by a vacuum suction present at the suction inlet of the housing;
a suction pipe connected to the sludge outlet, wherein said suction pipe provides a vacuum suction source for said submersible suction unit and removes said portion of said paint sludge through paint sludge inlet; and
a compressed air line connected to the air inlet wherein said compressed air line selectively fills the buoyancy chamber with air causing said submersible suction unit to move to said select vertical depth within the contaminant tank.

4. The submersible suction arrangement of claim 3 further comprising a sling line connected between the housing of the submersible suction unit and the suspension frame, wherein the sling line controls the movement of the submersible suction unit within the horizontal plane of the contaminant tank and said sling line partly controls the vertical depth of the submersible suction unit in combination with the buoyancy chamber.

5. The submersible suction arrangement of claim 4 further comprising a rail of the suspension frame extending over at least a portion of the contaminant tank, above the liquid mixture, wherein said rail connects to the sling line and said rail is movable within said horizontal plane of said contaminant tank to move said submersible suction unit within said horizontal plane.

6. The submersible suction unit of claim 5, wherein said rail is a movable horizontal beam extending from a vehicle allowing the submersible suction arrangement to be moved by the vehicle.

7. The submersible suction unit of claim 5, wherein said rail is a horizontal cable extending between two towers, said cable being located above the surface of the liquid mixture, wherein said two towers are each movable along an edge of said contaminant tank for moving said submersible suction unit within the horizontal plane of the contaminant tank.

8. The submersible suction arrangement of claim 7, wherein said cable is a circular loop connectable between wheels located on each one of said two towers;
one or more support trolleys slidable along the length of said cable; and
a lead trolley located adjacent the one or more support trolleys, said lead trolley is located above the submersible suction unit and is connected to said sling line with a guide that said sling line slides through.

9. The submersible suction unit of claim 7, wherein said one or more support trolleys and said lead support trolley further include a support arm that holds and supports a portion of said suction line and a portion of said compressed air line above the surface of said liquid mixture.

10. A submersible suction arrangement comprising:
a submersible suction unit that includes a housing containing a buoyancy chamber connected to an air inlet;
a suction passage extending through the housing between a paint sludge suction inlet and a sludge outlet formed in the housing;
a suction pipe connected to the sludge outlet;
a compressed air line connected to the air inlet wherein the compressed air line selectively fills the buoyancy chamber with compressed air; and
a suspension frame connected to said submersible suction unit for moving said submersible suction unit to one or more locations.

11. The submersible suction arrangement of claim 10, wherein said suspension frame is capable of completely moving the submersible suction unit from one location to another.

12. The submersible suction arrangement of claim 10 further comprising:
a sling line connected between the housing of the submersible suction unit and the suspension frame wherein the sling line directs the movement of the submersible suction unit between one or more locations.

13. The submersible suction arrangement of claim 12 further comprising a rail of the suspension frame, wherein the rail is a movable horizontal beam extending from a vehicle allowing the submersible suction arrangement to be moved by the vehicle.

14. The submersible suction unit of claim 10 further comprising a rail of the suspension frame, wherein the rail is a horizontal cable extending between two towers, wherein said two towers are each movable along a track for moving the submersible suction unit along a horizontal plane.

15. The submersible suction arrangement of claim 14 further comprising one or more support trolleys slidable along the length of said cable; and
a lead trolley located adjacent the one or more support trolleys, said lead trolley is located above the submersible suction unit and is connected to said sling line.

16. The submersible suction arrangement of claim 15 wherein said one or more support trolleys and said lead support trolley each further include a support arm that holds and suspends a portion of said suction line and a portion of said compressed air line above the submersible suction unit.
